(19) United States
(12) Patent Application Publication
(10) Pub. No.: US 2021/0231194 A1
(43) Pub. Date: Jul. 29, 2021

(54) ELONGATE OBJECT GUIDING DEVICE, AND ROLLER ATTACHMENT

(71) Applicant: TSUBAKIMOTO CHAIN CO., Osaka-shi, Osaka (JP)

(72) Inventor: Takayuki Tetsuka, Osaka-shi (JP)

(73) Assignee: TSUBAKIMOTO CHAIN CO., Osaka-shi, Osaka (JP)

(21) Appl. No.: 17/258,537

(22) PCT Filed: Jul. 24, 2019
(86) PCT No.: PCT/JP2019/028970

§ 371 Date: Jan. 7, 2021

(30) Foreign Application Priority Data
Jul. 25, 2018 (JP) 2018-139027

(51) Int. Cl. F16G 13/16; H02G 11/00

(52) U.S. Cl. CPC F16G 13/16; H02G 11/006

(57) ABSTRACT

An elongate object guiding device is provided with a protective guiding portion, guide rails, rollers, and magnets. The guide rails have magnetic guide surfaces that guide the protective guiding portion when the protective guiding portion reciprocates in a longitudinal direction while forming a cured part. The rollers are provided on the protective guiding portion, and are disposed in such a way as to be capable of rolling along the guide surfaces. The magnets are provided on the protective guiding portion in such a way as not to come into contact with the guide rails, and cause a magnetic force to act on the guide surfaces in such a way as to maintain a state of contact between the rollers and the guide surfaces.

### TECHNICAL FIELD

The present disclosure relates to an elongated object guiding device and a roller attachment that guide and protect an elongated object, such as a flexible cable or hose that supplies power or liquid to a movable unit of a machine tool, in an accommodated state as the movable unit moves.

### BACKGROUND ART

Patent Document 1 describes a known example of such a type of a guiding device for an elongated object. Such an elongated object guiding device includes a protective guide, which includes links, and guide rails. The links are pivotally connected in series to form an accommodation space therein to allow for accommodation of an elongated object. The protective guide is configured to protect and guide the elongated object accommodated in the accommodation space. The guide rails are configured to move back and forth to guide the protective guide as the protective guide moves back and forth in the longitudinal direction while the protective guide forms a curved portion.

The protective guide includes engagement portions arranged in the longitudinal direction to be engageable with the guide rails. The guide rails include guide grooves that extend in the longitudinal direction to engage with the engagement portions and guide the protective guide. When the protective guide is moved back and forth, the guide grooves restrict movement of the engagement portions in a direction intersecting the longitudinal direction and allow movement of the engagement portions in the longitudinal direction.

### PRIOR ART DOCUMENT

### Patent Document

Patent Document 1: Japanese Laid-Open Patent Publication No. 2017-89848

### SUMMARY OF THE INVENTION

### Problems that the Invention is to Solve

In the above elongated object guiding device, the guide grooves need to guide the engagement portions in the longitudinal direction. This results in the structure of the guide grooves being complicated, which, in turn, causes the structure of the guide rails to be complicated. Thus, there is room for improvement in simplifying the structure of the guide rails.

It is an object of the present disclosure to provide an elongated object guiding device and a roller attachment that simplify the structure of the guide rails.

### Means for Solving the Problems

The means for solving the problem and advantages will now be described.

An elongated object guiding device that solves the problem includes a protective guide including links that are pivotally connected in series to define an accommodation space therein allowing for accommodation of an elongated object, in which the protective guide protects and guides the elongated object accommodated in the accommodation space; a guide rail including a magnetic guide surface, in which the guide surface guides the protective guide as the protective guide moves back and forth in a longitudinal direction and a curved portion forms in the protective guide; at least one roller that is arranged on the protective guide and arranged to be rollable on the guide surface; and a magnet arranged on the protective guide so as not to contact the guide rail, in which the magnet applies magnetic force to the guide surface to maintain contact between the roller and the guide surface.

With this structure, contact between the roller and the guide surface is maintained by magnetic force so that the guide rail does not need to have a structure that holds the roller. This simplifies the structure of the guide rail.

In the elongated object guiding device, preferably, the at least one roller includes two rollers that are paired and arranged at two sides of the protective guide in a width direction that is orthogonal to the longitudinal direction, and the magnet is arranged in a portion of the protective guide that is located inward from the two rollers, which are paired, in the width direction.

This structure allows the size of the device to be reduced because the width of the protective guide can be narrowed as compared to when the magnet is arranged in portions of the protective guide that are located outward in the width direction from the two paired rollers.

In the elongated object guiding device, preferably, the at least one roller includes multiple rollers, and the rollers are arranged at equal intervals in the longitudinal direction.

With this structure, the protective guide is guided by the rollers in a balanced manner on the guide rail.

In the elongated object guiding device, preferably, the at least one roller is arranged at an inner side of the protective guide where the curved portion forms in the protective guide.

This structure allows the size of the guide rail to be reduced as compared with when the roller is arranged at the outer side of where the curved portion forms in the protective guide.

A roller attachment that solves the problem is attachable in a removable manner to an elongated object guiding device including a protective guide and a guide rail, in which the protective guide includes links that are pivotally connected in series to define an accommodation space therein allowing for accommodation of an elongated object, and the protective guide protects and guides the elongated object accommodated in the accommodation space, and the guide rail includes a magnetic guide surface, and the guide surface guides the protective guide as the protective guide moves back and forth in a longitudinal direction and a curved portion forms in the protective guide. The roller attachment includes a roller that is rollable on the guide surface, and a magnet arranged so as not to contact the guide rail, in which the magnet applies magnetic force to the guide surface to maintain contact between the roller and the guide surface.

With this structure, by attaching the roller attachment to an elongated object guiding device that does not include the roller, the roller will roll while contact between the roller and the guide surface is maintained by the magnetic force. This simplifies the structure of the guide rail because the guide rail does not need to have a structure that holds the roller.

### EFFECTS OF THE INVENTION

The present disclosure simplifies the structure of a guide rail.

### BRIEF DESCRIPTION OF THE DRAWINGS

FIG. 1 is a perspective view showing an elongated object guiding device according to one embodiment.

FIG. 2 is a perspective view showing a state in which one guide rail is omitted from FIG. 1.

FIG. 3 is a front view of the elongated object guiding device in FIG. 1.

FIG. 4 is a perspective view of a roller link.

FIG. 5 is a perspective view of the roller link shown in FIG. 4 as viewed from an opposite side.

FIG. 6 is a perspective view of a normal link.

FIG. 7 is a perspective view of the normal link shown in FIG. 6 as viewed from an opposite side.

FIG. 8 is a cross-sectional view showing a state when a roller link and a normal link are connected in a straight position.

FIG. 9 is a cross-sectional view showing a state when a roller link and a normal link are connected in a bent position.

FIG. 10 is a perspective view showing the elongated object guiding device when a protective guide is located at a rearward position.

FIG. 11 is a perspective view of a roller attachment in accordance with a modified example.

FIG. 12 is a perspective view showing a state when the roller attachment in FIG. 11 is coupled to a normal link.

FIG. 13 is a perspective view of a roller attachment in a modified example.

FIG. 14 is a perspective view of a roller link in a modified example.

FIG. 15 is a perspective view of a roller link in a modified example.

FIG. 16 is a perspective view of a roller link in a modified example.

FIG. 17 is a perspective view showing an elongated object guiding device in a modified example.

FIG. 18 is a front view showing an elongated object guiding device in a modified example.

FIG. 19 is a perspective view of a roller link in a modified example.

FIG. 20 is a perspective view of a roller link in a modified example.

FIG. 21 is a perspective view of a roller attachment in a modified example.

FIG. 22 is a perspective view showing a state when the roller attachment in FIG. 21 is coupled to a normal link.

FIG. 23 is a perspective view of a roller attachment in a modified example.

### MODES FOR CARRYING OUT THE INVENTION

An elongated object guiding device 11 according to one embodiment will now be described with reference to the drawings.

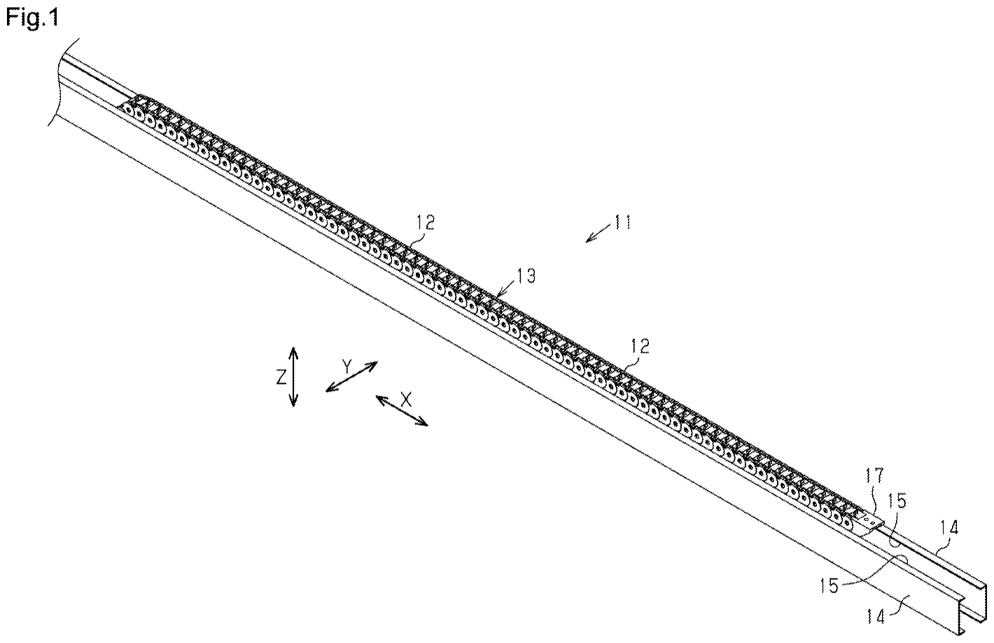

As shown in FIGS. 1 to 3, the elongated object guiding device 11 is elongated and arranged to extend along a horizontal plane. The elongated object guiding device 11 includes an elongated protective guide 13, which includes links 12, and two elongated guide rails 14. The links 12 are pivotally connected in series to internally form an accommodation space SK where an elongated object TK is accommodated. The protective guide 13 is configured to protect and guide the elongated object TK accommodated in the accommodation space SK. The two guide rails 14 are configured to guide the protective guide 13.

The two guide rails 14, made of, for example, a magnetic metal material such as stainless steel, have the form of substantially rectangular plates. The two guide rails 14 extend in the longitudinal direction X of the protective guide 13 and are spaced apart and opposed toward each other. The direction in which the two guide rails 14 are opposed toward each other corresponds to the width direction Y that is orthogonal to the longitudinal direction X of the protective guide 13. The transverse direction of each of the two guide rails 14 corresponds to the height direction Z that is orthogonal to both the longitudinal direction X and the width direction Y. In the present embodiment, the longitudinal direction X and the width direction Y are directions extending along horizontal planes, and the height direction Z is the vertical direction.

Each guide rail 14 includes two bent potions 15 formed by bending the two ends in the height direction Z at a right angle toward the other guide rail 14. In other words, in each guide rail 14, the two bent portions 15 are formed by bending the two ends in the height direction Z of the guide rail 14 at a right angle toward the inner side of the two guide rails 14 in the width direction Y. The inner surface of each bent portion 15 in the height direction Z defines a guide surface 16 that guides the protective guide 13.

The protective guide 13 is arranged between the two guide rails 14 so that a curved portion W forms in an intermediate portion on an apparatus body (not shown) to which the elongated object guiding device 11 is coupled. One end of the protective guide 13 in the longitudinal direction X is connected by a connection member 17 to a movable body (not shown) that is moved back and forth in the longitudinal direction X. Another end of the protective guide 13 in the longitudinal direction X is fixed to the apparatus body (not shown) by a fixation member 18.

The two guide rails 14 guide the protective guide 13 when the protective guide 13 moves back and forth in the longitudinal direction X as the curved portion W forms in an intermediate portion. In this case, the curved portion W of the protective guide 13 moves in the longitudinal direction X as the movable body (not shown) moves back and forth in the longitudinal direction X.

Examples of the elongated object TK include electric cables for supplying power to the movable body (not shown), optical fiber cables for transmitting signals to the movable body (not shown), hoses for supplying gas (e.g., air) or liquid (e.g., water or oil) to the movable body (not shown), and elongated articulated members that can be flexibly bent.

The protective guide 13 includes pairs of rollers 20 arranged at equal intervals in the longitudinal direction X. The rollers 20 are rollable on the guide surface 16. More specifically, the rollers 20 are paired so that one is arranged at each of the two sides of the protective guide 13 in the width direction Y. Further, the protective guide 13 includes pairs of magnets 21 that do not contact the guide surfaces 16 (guide rails 14). The magnets 21 apply magnetic force to the guide surfaces 16 to maintain contact between the rollers 20 and the guide surfaces 16.

The links 12 of the protective guide 13 include roller links 22, each having two rollers 20 and two magnets 21, and normal links 23, which do not have two rollers 20 or two magnets 21. That is, the roller links 22 each include two rollers 20 and two magnets 21, and the normal links 23 neither include the rollers 20 nor the magnets 21.

The protective guide 13 in the present embodiment is formed by pivotally connecting, in series, ten normal links 23 between every two roller links 22. Thus, with the links 12 of the protective guide 13 in the present embodiment, two rollers 20 and two magnets 21 are arranged at every eleventh link 12.

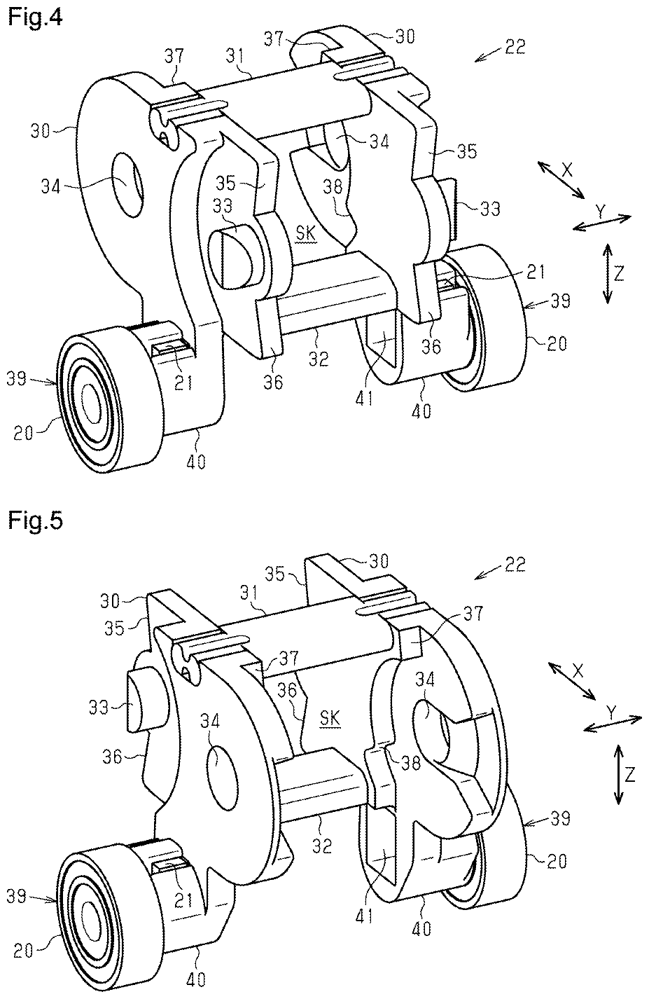

Referring to FIGS. 4 and 5, the roller link 22 includes two flat link portions 30 that are made of, for example, a synthetic resin material and opposed toward each other in the width direction Y. The two link portions 30 are connected by a first connection member 31 and a second connection member 32 at two sides in the height direction Z. The first connection member 31 and the second connection member 32 each have the form of a substantially rectangular plate.

The first connection member 31 is removably attached to the two link portions 30 and the second connection member 32 is formed integrally with the two link portions 30. The first connection member 31 and the second connection member 32 are opposed toward each other in the height direction Z. The open space surrounded by the two link portions 30, the first connection member 31, and the second connection member 32 defines the accommodation space SK.

The link portions 30 each include a projection 33 and a circular through-hole 34 into which the projection 33 of another link portion 30 adjacent in the longitudinal direction X is fitted in a relatively pivotal manner. The projection 33 is located on the outer surface of the link portion 30 in the vicinity of a first end of the link portion 30 in the longitudinal direction X. The through-hole 34 is located in the vicinity of a second end of the link portion 30 in the longitudinal direction X. A first stopper surface 35 is located on an end surface of the first end of the link portion 30 in the longitudinal direction X closer to the first connection member 31 than the projection 33. A second stopper surface 36 is located on the end surface of the first end of the link portion 30 in the longitudinal direction X closer to the second connection member 32 than the projection 33.

The link portion 30 also includes a first contact surface 37 that can contact the first stopper surface 35 of another link portion 30 adjacent in the longitudinal direction X. Specifically, the first contact surface 37 is located in the middle of the link portion 30 in the longitudinal direction X closer to the first connection member 31 than the through-hole 34. The link portion 30 also includes a second contact surface 38 that can contact the second stopper surface 36 of another link portion 30 adjacent in the longitudinal direction X. Specifically, the second contact surface 38 is located in the middle of the link portion 30 in the longitudinal direction X closer to the second connection member 32 than the through-hole 34.

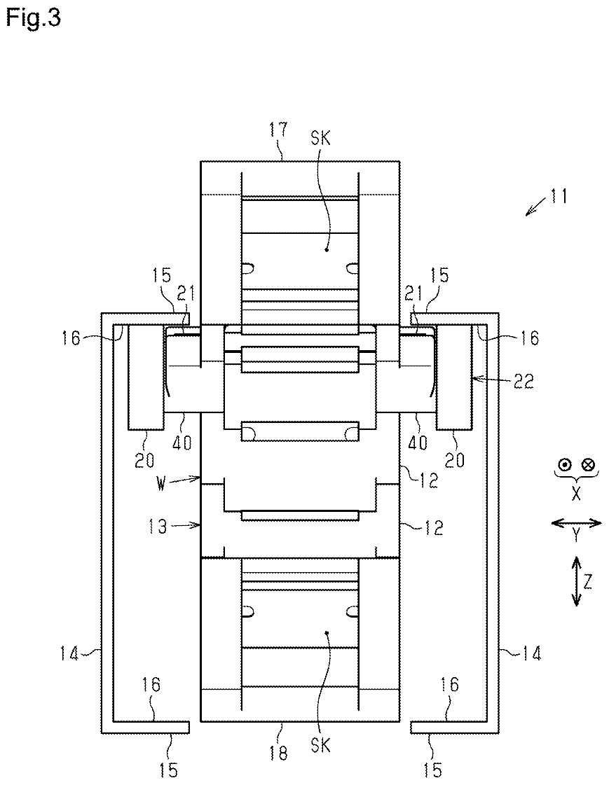

Each link portion 30 includes a roller unit 39 at the end at the side of the second connection member 32 in the height direction Z. That is, two link portions 30 include two roller units 39. The roller units 39 each include an arm 40, the roller 20, and the magnet 21. The arm 40 is L-shaped and bent at a right angle extending outward in the width direction Y from the link portion 30. The roller 20 is rotationally attached to the distal end of the arm 40 so that the roller 20 is rollable on the guide surface 16 (refer to FIG. 3). The magnet 21 is located on the arm 40 inward in the width direction Y from the roller 20.

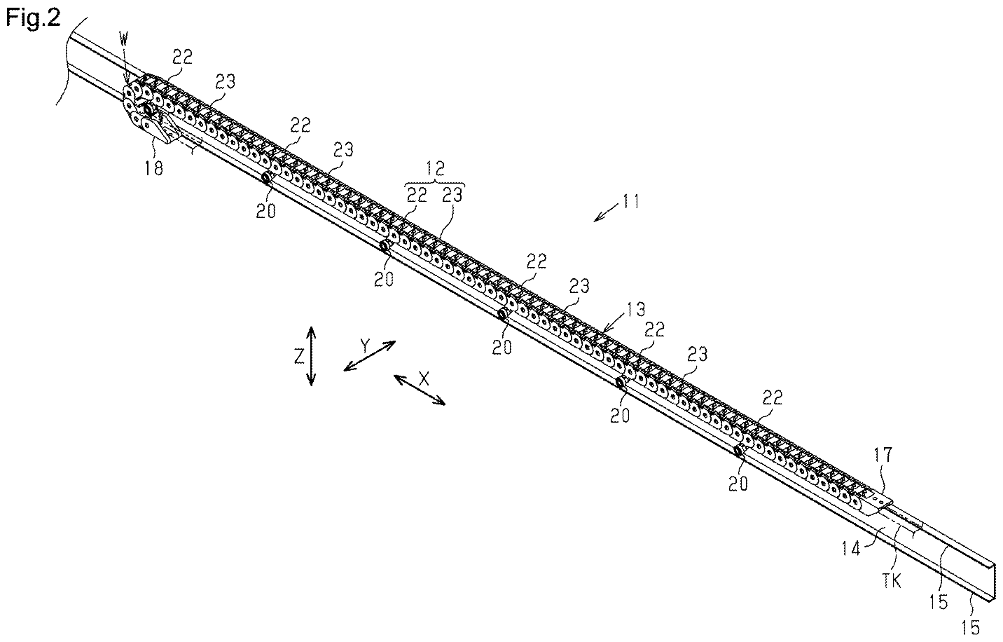

The arm 40 is formed, for example, integrally with the link portion 30 of the roller link 22. The magnet 21 is accommodated in a magnet accommodation portion 41 in the arm 40, which is located inward in the width direction Y from the roller 20. The end of the magnet 21 that is closer to the link portion 30 is partially exposed. As shown in FIG. 2, the rollers 20 (roller units 39) are arranged at the inner side of the protective guide 13 where the curved portion W forms in the protective guide 13.

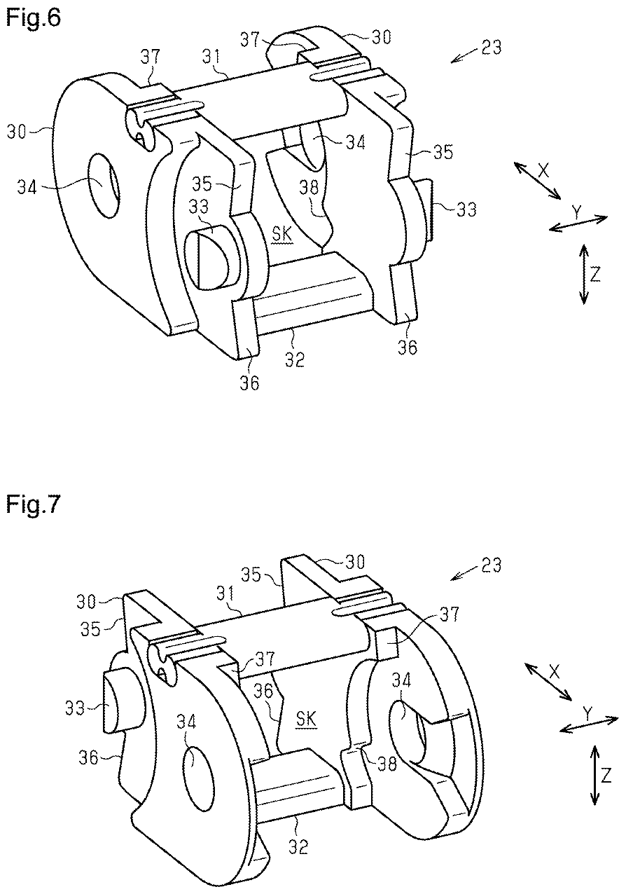

Further, as shown in FIGS. 6 and 7, the normal link 23 is equivalent to the roller link 22 shown in FIGS. 4 and 5 without the two roller units 39. Thus, in the normal link 23, the same reference numerals are given to those components that are the same as the roller link 22. Such components will not be described in detail.

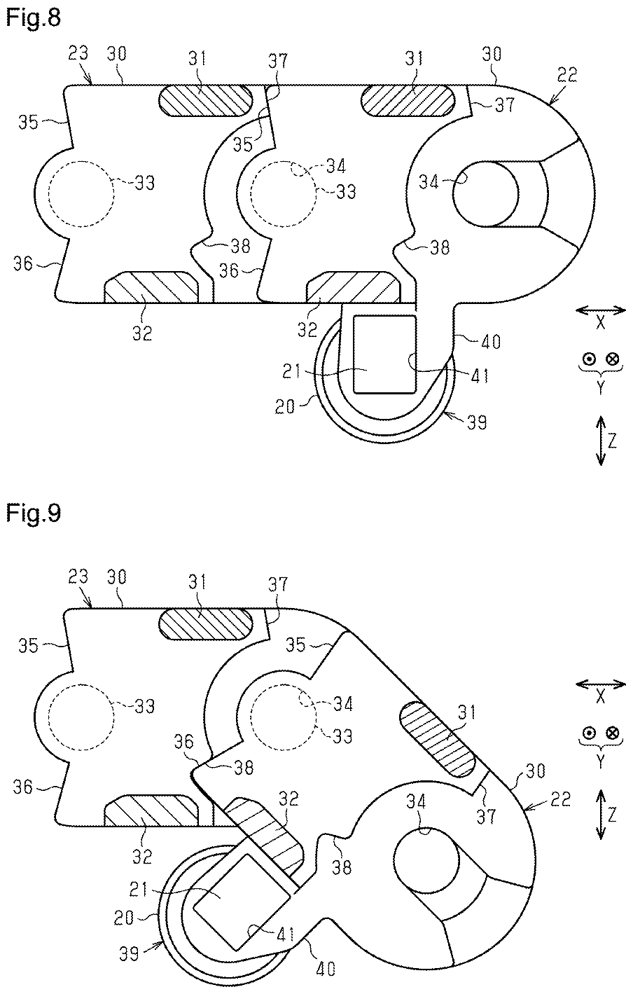

As shown in FIGS. 8 and 9, the roller link 22 is connected to an adjacent one of the normal links 23 in the longitudinal direction X by pivotally fitting the projections 33 of the link portions 30 of one of the links 22, 23 into the through-holes 34 of the link portions 30 of the other one of the links 22, 23. When the roller link 22 and the normal link 23 are connected, the link portions 30 of the roller link 22 and the link portions 30 of the normal link 23 are pivotal about the through-holes 34 and the projections 33 between a straight position and a bent position. In the straight position, the link portions 30 of the roller link 22 and the link portions 30 of the normal link 23 are arranged straight. The straight position corresponds to the position shown in FIG. 8. In the bent position, the link portions 30 of the roller link 22 and the link portions 30 of the normal link 23 are arranged bent from each other. The bent position corresponds to the position shown in FIG. 9.

In the present embodiment, when the roller link 22 and the adjacent one of the normal links 23 in the longitudinal direction X are in the straight position, the angle between the link portion 30 of the roller link 22 and the link portion 30 of the normal link 23 is zero degrees. Further, in the present embodiment, when the roller link 22 and the adjacent one of the normal links 23 in the longitudinal direction X are in the bent position, the angle between the link portion 30 of the roller link 22 and the link portion 30 of the normal link 23 is 30 degrees.

When the roller link 22 and the adjacent one of the normal links 23 in the longitudinal direction X are in the straight position, as shown in FIG. 8, the first stopper surfaces 35 of the link portions 30 of one of the links 22, 23 contact the first contact surfaces 37 of the link portions 30 of the other one of the links 22, 23, and the second stopper surfaces 36 of the link portions 30 of the one of the links 22, 23 are spaced apart from the second contact surfaces 38 of the link portions 30 of the other one of the links 22, 23.

When the roller link 22 and the adjacent one of the normal links 23 in the longitudinal direction X are in the bent position, as shown in FIG. 9, the first stopper surfaces 35 of the link portions 30 of one of the links 22, 23 are spaced apart from the first contact surfaces 37 of the link portions 30 of the other one of the links 22, 23, and the second stopper surfaces 36 of the link portions 30 of the one of the links 22, 23 contact the second contact surfaces 38 of the link portions 30 of the other one of the links 22, 23.

Thus, the first stopper surfaces 35 and the second stopper surfaces 36 respectively contact the first contact surfaces 37 and the second contact surfaces 38 to restrict the pivot range of the roller link 22 and the adjacent one of the normal links 23 in the longitudinal direction X to an angular range of 0 to 30 degrees in the present embodiment.

The connection between normal links 23 is the same as the connection between the roller link 22 and the normal link 23 and thus will not be described.

As shown in FIGS. 2 and 3, the dimensions of the guide rails 14 in the width direction Y are set so that the two rollers 20 and the two magnets 21 of the roller link 22 are opposed toward the guide surfaces 16 in the height direction Z. In this case, portions of each roller link 22 other than the rollers 20 are completely separated from the guide rails 14. In other words, only the rollers 20 of the roller link 22 contact the guide surfaces 16 of the guide rails 14. Each normal link 23 is completely separated from the guide rails 14.

The operation of the elongated object guiding device 11 will now be described.

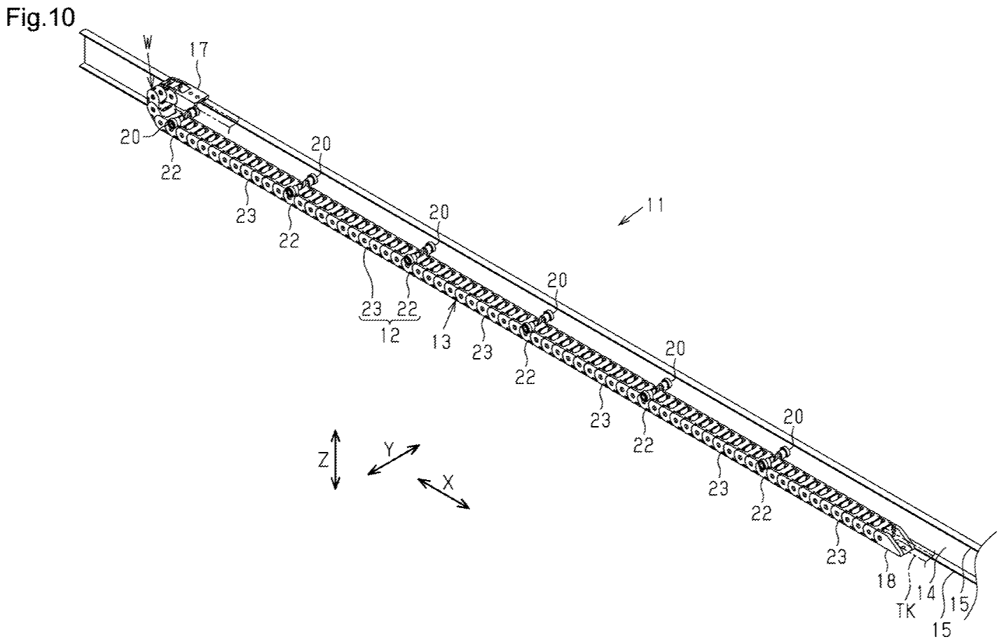

The fixation member 18 of the protective guide 13 is fixed to the apparatus body (not shown). Thus, when the connection member 17 of the protective guide 13 connected to the movable body (not shown) is moved back and forth together with the movable body in the longitudinal direction X, the protective guide 13 is moved back and forth in the longitudinal direction X so that the curved portion W moves to follow the movable body. In this case, the protective guide 13 is moved back and forth between a forward position shown in FIG. 2 and a rearward position shown in FIG. 10.

Thus, the protective guide 13 protects and guides the elongated object TK accommodated in the accommodation space SK as the movable body (not shown) moves back and forth. In the protective guide 13, the roller links 22 and the adjacent ones of the normal links 23 in the longitudinal direction X are repeatedly pivoted between the straight position and the bent position as the curved portion W moves back and forth. Further, the ones of the normal links 23 adjacent in the longitudinal direction X are repeatedly pivoted between the straight position and the bent position in the same manner as the roller links 22 and the adjacent ones of the normal links 23 in the longitudinal direction X that are pivoted as described above.

When the protective guide 13 is moved back and forth, only the rollers 20 of the roller link 22 roll on the upper guide surfaces 16. This significantly reduces movement resistance as compared with when the protective guide 13 slides on the guide surfaces 16 and effectively reduces the formation of abrasive wear debris. When the protective guide 13 is moved back and forth, the magnets 21 of each roller link 22 apply magnetic force to the upper guide surfaces 16 to maintain contact between the upper guide surfaces 16 and the rollers 20.

More specifically, the rollers 20 of the protective guide 13 roll while attracted to the upper guide surfaces 16 by the magnetic force (magnetic attraction) of the magnets 21. Thus, even when the protective guide 13 is elongated and moved over a long distance, the protective guide 13 stably and smoothly travels on the upper guide surfaces 16 without sagging due to its weight. In this case, the magnets 21 are free from wear and breakage as the magnets 21 do not contact the guide rails 14.

The above described present embodiment has the following advantages.

(1) The elongated object guiding device 11 includes the guide rails 14, which include the magnetic guide surfaces 16 that guide the protective guide 13, the rollers 20, which are arranged on the protective guide 13 and rollable on the guide surfaces 16, and the magnets 21, which are arranged on the protective guide 13 to apply magnetic force to the guide surfaces 16 in order to maintain contact between the rollers 20 and the guide surfaces 16. With this structure, contact between the rollers 20 and the guide surfaces 16 is maintained by the magnetic force so that the guide rails 14 do not need to have a structure that holds the rollers 20. This simplifies the structure of the guide rails 14.

(2) The rollers 20 of the elongated object guiding device 11 are paired so that one is arranged at each of the two sides of the protective guide 13 in the width direction Y. The magnets 21 are arranged in portions of the protective guide 13 that are located inward in the width direction Y from the two paired rollers 20. This structure allows the size of the device to be reduced because the width of the protective guide 13 can be narrowed as compared to when the magnets 21 are arranged in portions of the protective guide 13 that are located outward in the width direction Y from the two paired rollers 20.

(3) The protective guide 13 of the elongated object guiding device 11 includes the rollers 20 arranged at equal intervals in the longitudinal direction X. With this structure, the protective guide 13 is guided by the rollers 20 in a balanced manner on the guide rails 14.

(4) The rollers 20 of the elongated object guiding device 11 are arranged at the inner side of the protective guide 13 where the curved portion W forms in the protective guide 13. This structure allows the size of the guide rails 14 to be reduced because the guide rails 14 can be shortened in the height direction Z as compared with when the rollers 20 are arranged at the outer side of where the curved portion W forms in the protective guide 13.

Modified examples

The above described embodiment may be modified as follows.

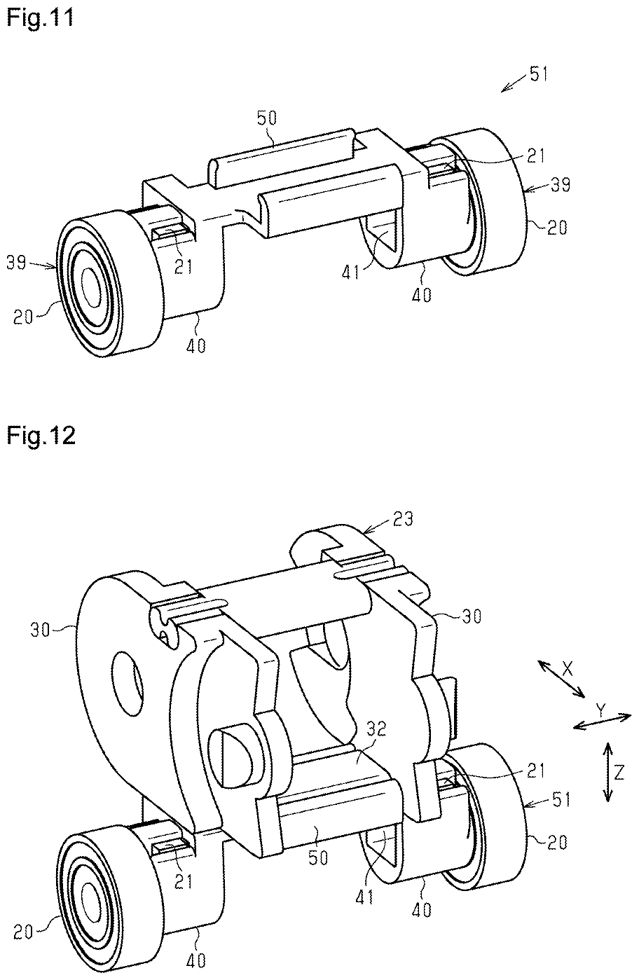

As shown in FIGS. 11 and 12, two roller units 39 may be coupled to an attachment member 50, which is connectable in a removable manner to the second connection member 32 of a normal link 23, to form a roller attachment 51. The roller attachment 51 is attached to an elongated object guiding device that does not include the rollers 20 (roller links 22 of elongated object guiding device 11 are all replaced by normal links 23) so that the elongated object guiding device that does not include the rollers 20 has the same functionality as the elongated object guiding device 11 of the above embodiment. More specifically, as shown in FIG. 12, when the roller attachment 51 is attached to the second connection member 32 of the normal link 23, the normal link 23 has the same functionality as the roller link 22. Thus, by merely attaching the roller attachment 51 to an elongated object guiding device that does not include the rollers 20, the rollers 20 will roll while contact between the rollers 20 and the guide surfaces 16 is maintained by the magnetic force of the magnets 21. This simplifies the structure of the guide rails 14 because the guide rails 14 do not need to have a structure that holds the rollers 20.

As shown in FIG. 13, the roller attachment 51 shown in FIG. 11 may be cut in the middle of the attachment member 50 to form a roller attachment 52. In this case, one roller attachment 52 may be attached to one normal link 23. Alternatively, two roller attachments 52 may be attached to one normal link 23. That is, the roller 20 and the magnet 21 can be attached as a single unit to the second connection member 32 of the normal link 23.

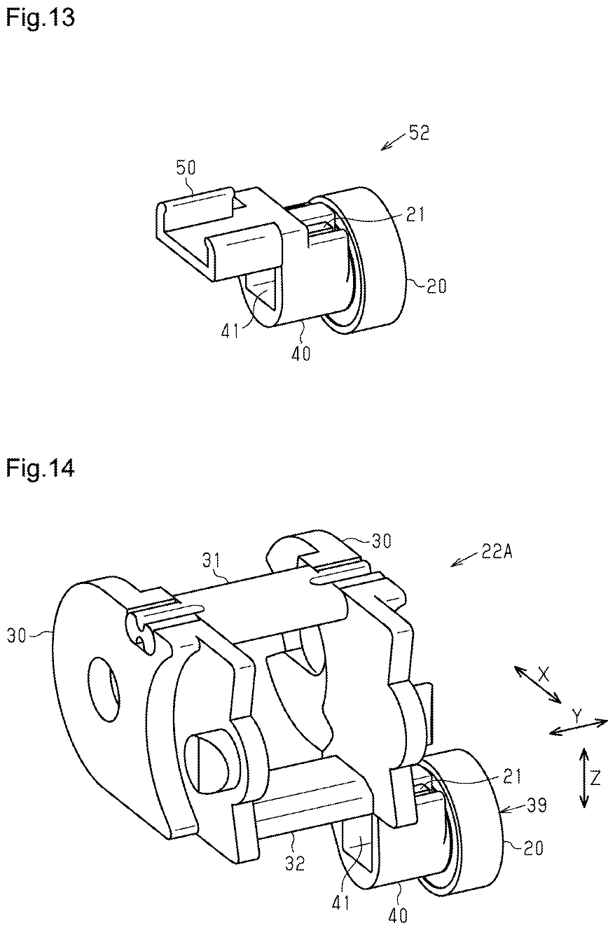

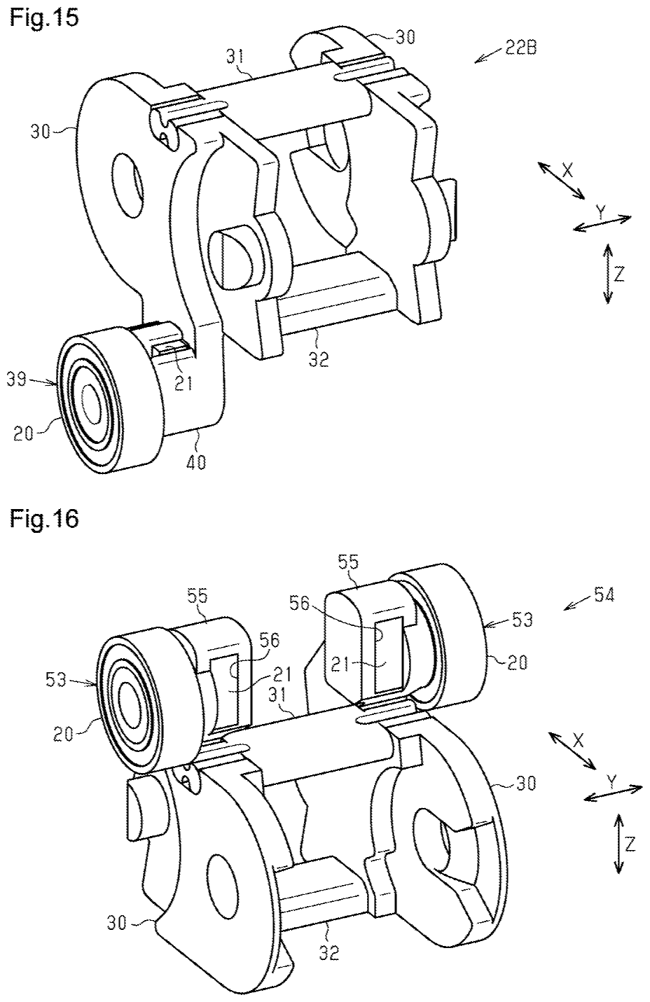

The protective guide 13 of the elongated object guiding device 11 may be formed by pivotally and alternately connecting a roller link 22A, which is shown in FIG. 14 and obtained by omitting one of the two roller units 39 from the roller link 22, and a roller link 22B, which is shown in FIG. 15 and obtained by omitting the other one of the two roller units 39 from the roller link 22, in series. In this case, the roller link 22A and the roller link 22B may be directly connected. Alternatively, a given number of the normal links 23 may be arranged between the roller link 22A and the roller link 22B.

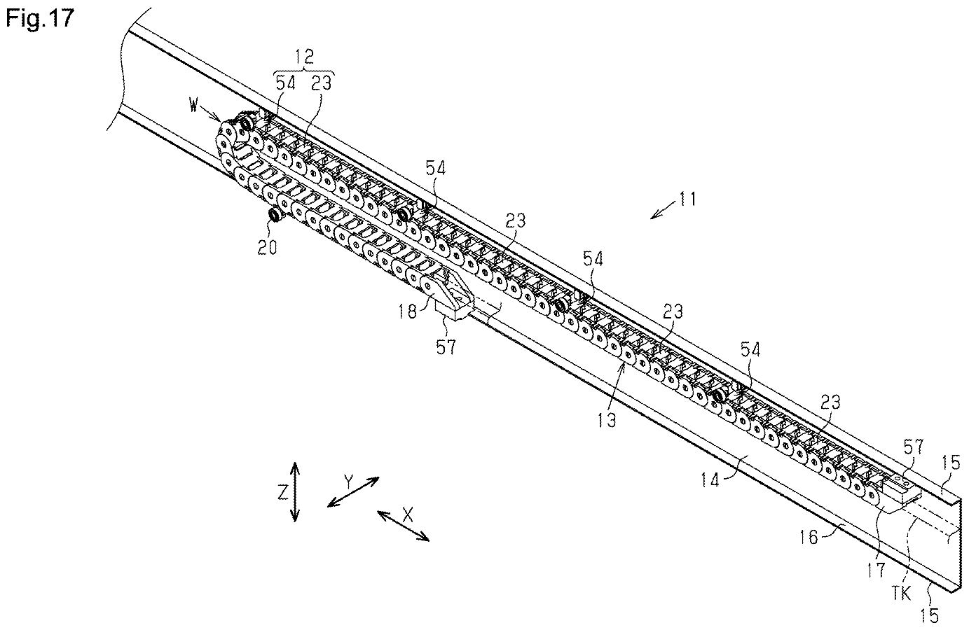

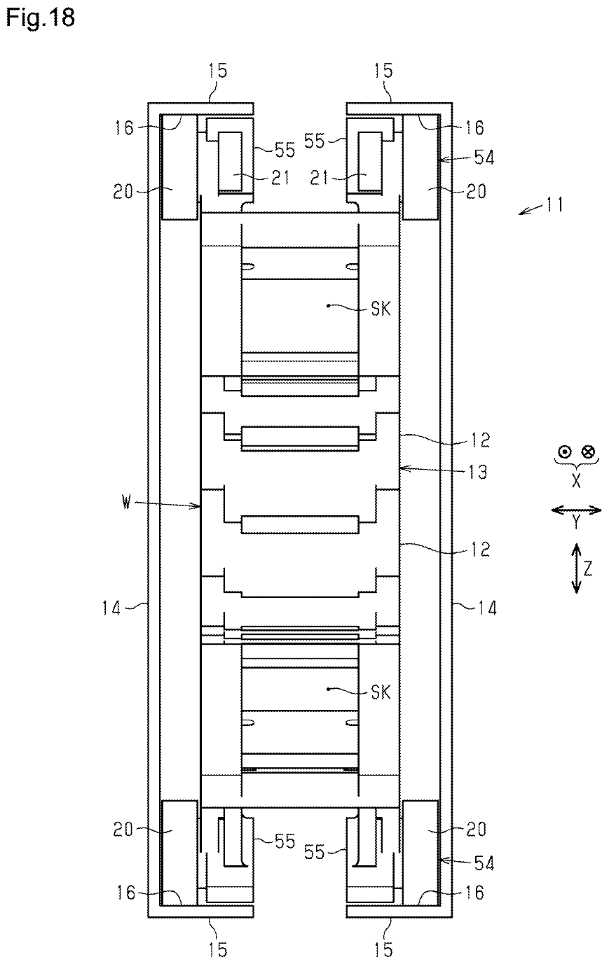

As shown in FIGS. 16 and 17, instead of the roller link 22, the elongated object guiding device 11 may use a roller link 54 obtained by forming a roller unit 53 integrally with the end of each link portion 30 of the normal link 23 at the side of the first connection member 31. Each roller unit 53 includes a block-shaped arm 55, the roller 20, and the magnet 21. The arm 55 is arranged on the end of the link portion 30 of the normal link 23 at the side of the first connection member 31. The roller 20 is rotationally attached to the outer end of the arm 55 in the width direction Y and rollable on the guide surface 16 (refer to FIG. 18). The magnet 21 is accommodated in a magnet accommodating portion 56 of the arm 55. In this case, the rollers 20 are arranged at the outer side of the protective guide 13 when the curved portion W forms in the protective guide 13. Thus, the guide rails 14 need to be lengthened in the height direction Z to allow the rollers 20 to smoothly roll on the guide surfaces 16. In this case, the protective guide 13 is entirely arranged between the two guide rails 14 so that joints 57 connected to the movable body (not shown) and the apparatus body (not shown) are attached to the connection member 17 and the fixation member 18. In FIG. 18, the joints 57 are not shown. In the roller unit 53 shown in FIG. 16, the magnets 21 are not exposed from the sides of the arms 55 that are opposed toward the guide surfaces 16 (upper side in FIG. 16). However, the magnets 21 may be exposed.

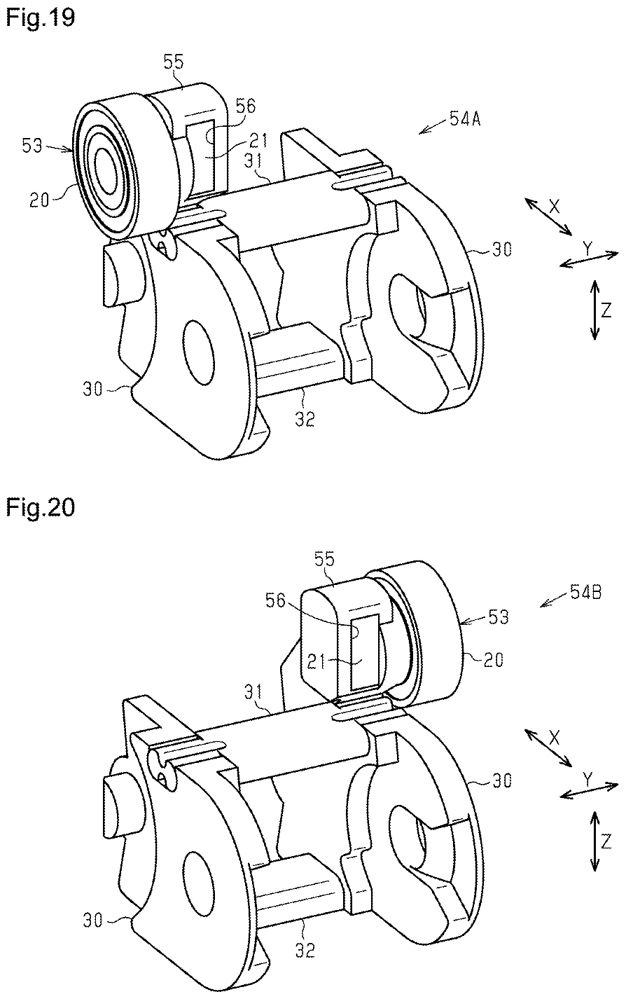

The protective guide 13 of the elongated object guiding device 11 may be formed by pivotally and alternately connecting a roller link 54A, which is shown in FIG. 19 and obtained by omitting one of the two roller units 53 from the roller link 54, and a roller link 54B, which is shown in FIG. 20 and obtained by omitting the other one of the two roller units 53 from the roller link 54, in series. In this case, the roller link 54A and the roller link 54B may be directly connected. Alternatively, a given number of the normal links 23 may be arranged between the roller link 54A and the roller link 54B.

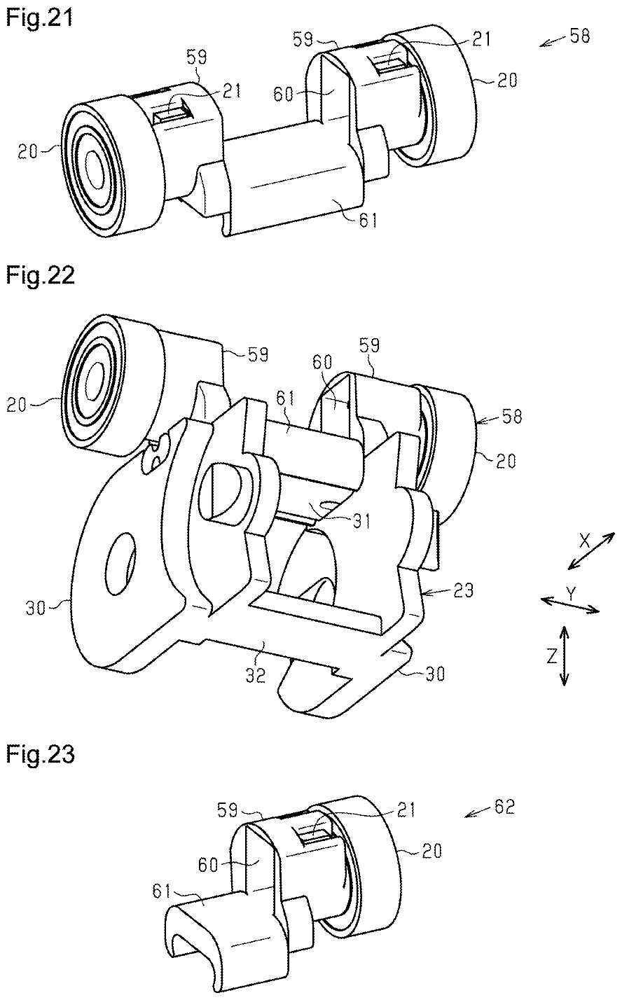

As shown in FIGS. 21 and 22, a roller attachment 58 may be attached in a removable manner to the first connection member 31 of the normal link 23. The roller attachment 58 includes the two rollers 20, two arms 59 that are arranged at an inner side of the two rollers 20 to rotationally support the two rollers 20, the two magnets 21 accommodated in magnet accommodating portions 60 of the two aims 59, and an attachment member 61 that is arranged between the two arms 59 to connect the two arms 59 and attachable in a removable manner to the first connection member 31 of the normal link 23. In this case, the magnets 21 are exposed from the side of the arms 59 that is opposed toward the guide surfaces 16 (upper side in FIG. 21). When the roller attachment 58 is attached to an elongated object guiding device that does not include the rollers 20 (roller links 22 of elongated object guiding device 11 are all replaced by normal links 23) so that the elongated object guiding device that does not include the rollers 20 has the same functionality as the elongated object guiding device 11 of the above embodiment. Thus, as shown in FIG. 22, when the roller attachment 58 is attached to the first connection member 31 of the normal link 23, the normal link 23 will have the same functionality as the roller link 54 (refer to FIG. 16).

As shown in FIG. 23, the roller attachment 58 shown in FIG. 21 may be cut in the middle of the attachment member 61 to form a roller attachment 62. In this case, one roller attachment 62 may be attached to one normal link 23. Alternatively, two roller attachments 62 may be attached to one normal link 23. That is, the roller 20 and the magnet 21 can be attached as a single unit to the first connection member 31 of the normal link 23.

The guide rail 14 may be divided into multiple segments.

The links 12 included in the protective guide 13 may all be the roller links 22.

In the protective guide 13, the number of normal links 23 arranged between two roller links 22 in the longitudinal direction X may be changed from ten to any number.

The roller links 22 (rollers 20) of the protective guide 13 do not necessarily have to be arranged at equal intervals in the longitudinal direction X.

The magnet 21 may be arranged outward from the roller 20 in the width direction Y. The magnet 21 may be arranged inside the roller 20.

One of the two magnets 21 of the roller link 22 may be omitted.

The guide rails 14 do not have to be completely made of a magnetic material as long as at least the guide surface 16 is made of a magnetic material.

The elongated object guiding device 11 when used may be arranged so that the longitudinal direction X intersects a horizontal plane.

### DESCRIPTION OF THE REFERENCE NUMERALS

11 . . . elongated object guiding device, 12 . . . link, 13 . . . protective guide, 14 . . . guide rail, 16 . . . guide surface, 20 . . . roller, 21 . . . magnet, 51, 52, 58, 62 . . . roller attachment, SK . . . accommodation space, TK . . . elongated object, X . . . longitudinal direction, Y . . . width direction, W . . . curved portion

1-5. (canceled)

6. An elongated object guiding device comprising:
a protective guide including links that are pivotally connected in series to define an accommodation space therein allowing for accommodation of an elongated object, wherein the protective guide protects and guides the elongated object accommodated in the accommodation space;
a guide rail including a magnetic guide surface, wherein the guide surface guides the protective guide as the protective guide moves back and forth in a longitudinal direction and a curved portion forms in the protective guide;
at least one roller that is arranged on the protective guide and arranged to be rollable on the guide surface; and
a magnet arranged on the protective guide so as not to contact the guide rail and opposed toward the guide surface on which the roller rolls, wherein the magnet applies magnetic force to the guide surface to maintain contact between the roller and the guide surface when the protective guide moves back and forth.

7. The elongated object guiding device according to claim 6, wherein
the at least one roller includes two rollers that are paired and arranged at two sides of the protective guide in a width direction that is orthogonal to the longitudinal direction, and
the magnet is arranged in a portion of the protective guide that is located inward from the two rollers, which are paired, in the width direction and outward from the accommodation space in the width direction.

8. The elongated object guiding device according to claim 6, wherein
the at least one roller includes multiple rollers, and
the rollers are arranged at equal intervals in the longitudinal direction.

9. The elongated object guiding device according to claim 6, wherein the at least one roller is arranged, at an inner side of the protective guide where the curved portion forms in the protective guide.

10. A roller attachment that is attachable, in a removable manner, to an elongated object guiding device including a protective guide acid a guide rail, wherein the protective guide includes links that are pivotally connected in series to define an accommodation space therein allowing for accommodation of an elongated object, and the protective guide protects and guides the elongated object accommodated in the accommodation space, and the guide rail includes a magnetic guide surface, and the guide surface guides the protective guide as the protective guide moves back and forth in a longitudinal direction and a curved portion forms in the protective guide, the roller attachment comprising:
a roller that is rollable on the guide surface; and
a magnet arranged so as not to contact the guide rail, wherein the magnet applies magnetic force to the guide surface to maintain contact between the roller and the guide surface.
